(19) United States
(12) Patent Application Publication
(10) Pub. No.: US 2016/0160768 A1
(43) Pub. Date: Jun. 9, 2016

(54) METHOD FOR PREVENTING ENGINE STALL USING VIRTUAL CRANK SIGNAL

(71) Applicant: Hyundai Motor Company, Seoul (KR)

(72) Inventor: Bon Chang KOO, Seongnam-si (KR)

(21) Appl. No.: 14/931,722

(22) Filed: Nov. 3, 2015

(30) Foreign Application Priority Data
Dec. 4, 2014 (KR) 10-2014-0172910

(51) Int. Cl. F02D 31/00; G01M 15/06

(52) U.S. Cl. CPC F02D 31/001; G01M 15/06

(57) ABSTRACT

A method for preventing an engine stall by a virtual crank signal includes determining stability of the engine by measuring an operating time of the engine, storing a crank signal, with a virtual crank signal storing step, using a crank position sensor while a crank shaft makes one turn if it is determined that the stability of the engine is maintained, determining whether the crank position sensor is out of order, and controlling an engine RPM by the crank signal stored in the virtual crank signal storing step to perform idle driving of a vehicle at the time of a breakdown of the crank position sensor.

### CROSS REFERENCE TO RELATED APPLICATION

The present application claims the benefit of priority to Korean Patent Application Number 10-2014-0172910, filed on Dec. 4, 2014 with the Korean Intellectual Property Office, the entire contents of which are incorporated herein by reference.

### TECHNICAL FIELD

The present disclosure relates to a method for preventing an engine stall by a virtual crank signal, and more particularly, to a technology for preventing an engine stall prior to controlling the engine using a cam position sensor, by controlling the engine based on revolutions per minute measured by a pre-stored virtual crank signal at the time of abnormality of a crank position sensor.

### BACKGROUND

As illustrated in FIG. 1, an ignition timing control apparatus controlling ignition timing of an engine includes a sensor 1 configured to sense an input of a sensing signal required for an ignition input, an ECU 2 configured to calculate an engine load (A/N) based on the sensing signal of the sensor 1 and then control the ignition timing, and an igniter 3 configured to supply a primary current of an ignition coil (not illustrated) according to an output signal of the ECU 2 to generate a high voltage and allow the supplied high voltage to generate a spark to ignite a mixer.

In this configuration, the sensor 1 includes a crank position sensor 1a, a cam position sensor 1b, a water temperature sensor 1c, and a suction air flow meter 1d.

In a general vehicle configured as described above, first, the ECU 2 measures an engine RPM using the sensing signal of the crank position sensor 1a and measures an air content using the suction air flow meter 1d to calculate a ratio of air content A to engine RPM N, that is, the engine load A/N. The ECU 2 then calculates optimal ignition timing using the calculated result, thereby supplying a signal to the igniter 3.

The sensor 1 required to determine the ignition timing is installed at a crank shaft and a cam shaft, respectively. As illustrated in FIG. 2, the crank position sensor 1a installed at the crank shaft outputs a crank signal having a waveform in response to the number of teeth of a trigger wheel installed on the surface of the crank shaft, and the cam position sensor 1b outputs a cam signal having a waveform sensed around a protruding part of the cam.

As described above, in controlling the engine of the vehicle, the crank position sensor 1a plays an important role of controlling fuel and an ignition angle. In this case, when an error of a crank angle sensing signal occurs due to a breakdown of the crank position sensor 1a, it is determined that the engine has stopped and thus the engine is stalled.

Here, an error determination of the crank position sensor 1a is made when the crank angle sensing signal is not input or the input of the crank angle sensing signal is larger or smaller than a defined frequency per two rotations of the engine even though the sensing signal of the cam position sensor is input by a predetermined frequency or more.

At the time of the error determination of the crank angle sensor as described above, the ECU 2 divides a time between inputs of the sensing signal supplied from the cam position sensor by an input frequency of the crank signal to be input while the engine makes one turn, sets the input time to be an input time per one crank signal, corrects the crank signal by a learning process corresponding to the set time, and outputs the corrected crank signal.

Meanwhile, a cylinder may not be discriminated at the time of the signal abnormality of the crank position sensor and therefore it is impossible to control a fuel quantity and the ignition timing, such that the engine is stalled.

To prevent this, as described above, the engine RPM is controlled using the cam position sensor.

However, when the engine RPM is low, the engine may be stalled prior to controlling the engine RPM using the cam position sensor.

Accordingly, an object of the present disclosure provides a technology of preventing the engine stall phenomenon prior to controlling the engine using the cam position sensor, by controlling the engine based on the revolutions per minute measured by the pre-stored virtual crank signal at the time of the abnormality of the crank position sensor.

The contents described as the related art have been provided only for assisting in the understanding for the background of the present disclosure and should not be considered as corresponding to the related art known to those skilled in the art.

### SUMMARY OF THE DISCLOSURE

An object of the present disclosure is to provide a technology of preventing an engine stall phenomenon prior to controlling the engine using a cam position sensor, by controlling the engine based on revolutions per minute measured by a pre-stored virtual crank signal at the time of abnormality of a crank position sensor.

According to an exemplary embodiment of the present disclosure, there is provided a method for preventing an engine stall by a virtual crank signal, including: a first stabilization determining step of determining stability of the engine by measuring an operating time of the engine; a virtual crank signal storing step of storing a crank signal using a crank position sensor while a crank shaft makes one turn, if it is determined that the stability of the engine is kept; a step of determining whether the crank position sensor is out of order; and an idle driving step of controlling an engine RPM by the crank signal stored in the virtual crank signal storing step to perform idle driving of a vehicle at the time of a breakdown of the crank position sensor.

In the step of determining whether the crank position sensor is out of order, the engine RPM may be controlled by the crank signal measured using the crank position sensor if it is determined that the crank position sensor is normal.

The method may further include: after the idle driving step, a step of detecting the engine RPM using a cam position sensor; a second stabilization determining step of determining the stability of the engine by comparing the engine RPM sensed using the cam position sensor with a set reference value; and a step of controlling the engine based on the engine RPM sensed using the cam position sensor when the engine RPM sensed using the cam position sensor exceeds the set reference value.

The method may further include: after the idle driving step, a step of detecting the engine RPM using a cam position sensor; a second stabilization determining step of determining the stability of the engine by comparing the engine RPM sensed using the cam position sensor with a set reference value; and a step of controlling the engine based on the engine RPM sensed using the crank signal stored in the virtual crank signal storing step when the engine RPM sensed using the cam position sensor is smaller than the set reference value.

In the first stabilization determining step of determining whether the engine is normally operated by measuring the operating time of the engine, it may be determined that the engine is stably operated when the operating time of the engine exceeds the set reference time by comparing the operating time of the engine with the set reference time.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating a configuration of the existing ignition timing control apparatus of a vehicle;

FIG. 2 is a waveform diagram illustrating a signal sensed by a cam position sensor and a crank position sensor;

FIG. 3 is an overall flow chart of a method for preventing an engine stall by a virtual crank signal according to an exemplary embodiment of the present disclosure; and

FIG. 4 is a flow chart illustrating in detail each step of the flow chart of FIG. 3.

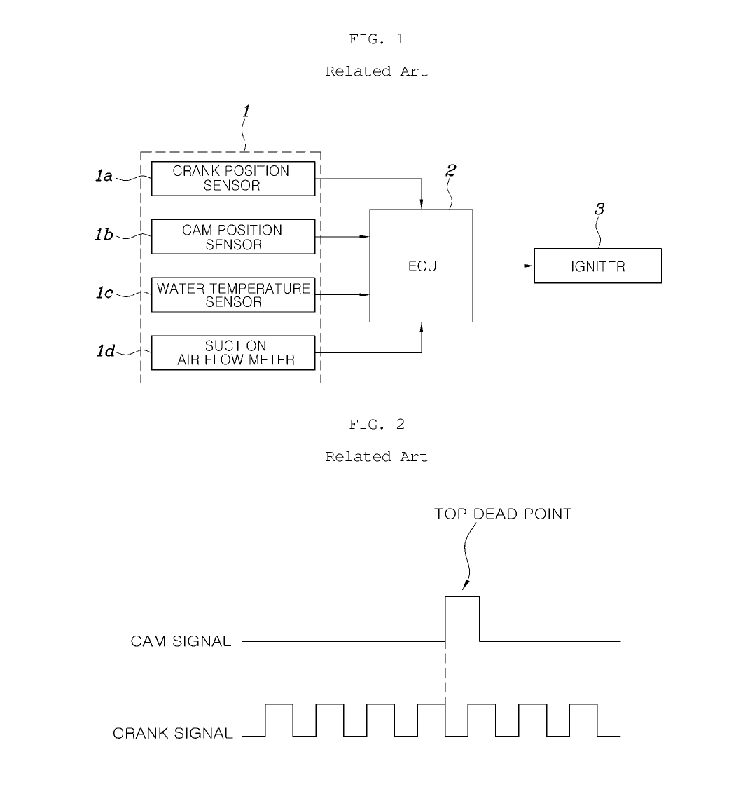

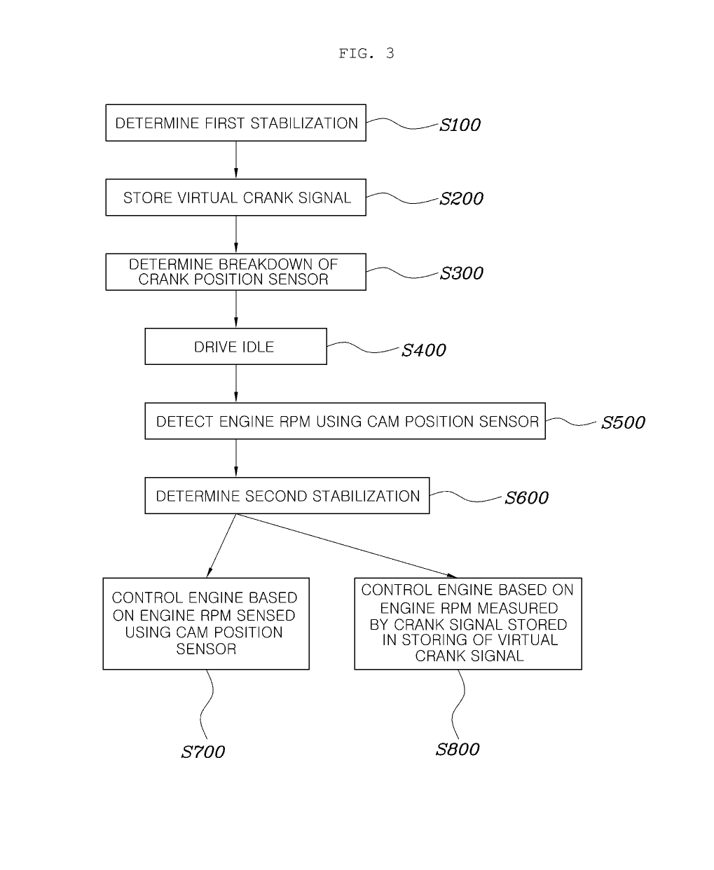

### DETAILED DESCRIPTION

Hereinafter, a method for preventing an engine stall by a virtual crank signal according to an exemplary embodiment of the present disclosure will be described with reference to the accompanying drawings.

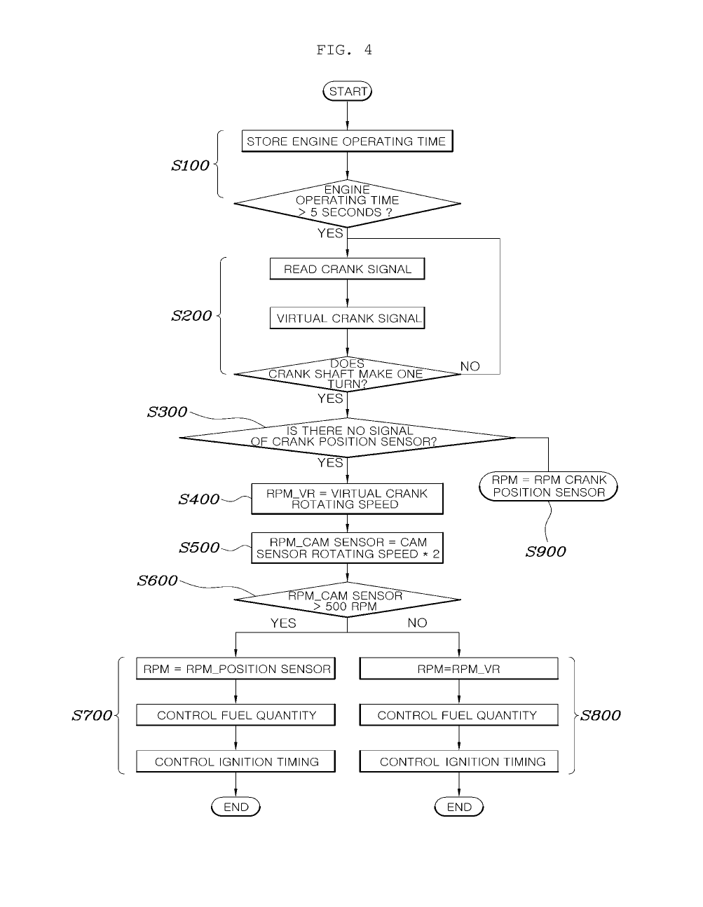

FIG. 3 is an overall flow chart of a method for preventing an engine stall by a virtual crank signal according to an exemplary embodiment of the present disclosure. FIG. 4 is a flow chart illustrating in detail each step of the flow chart of FIG. 3.

As illustrated in FIG. 3, the method for preventing an engine stall by a virtual crank signal according to an exemplary embodiment of the present disclosure first includes determining first stabilization (S100), storing a virtual crank signal (S200), determining whether a crank position sensor is out of order (S300), and idle driving (S400).

The determining of the first stabilization (S100) measures an operating time of the engine to determine the stability of the engine.

That is, when the engine is operated, time from the operating timing of the engine to the present time is stored in the ECU. It is first determined whether the engine is stabilized by comparing the stored time with a reference time pre-stored in the ECU.

This is to store the crank signal measured using a crank position sensor in the storing of the virtual crank signal to be described below after the engine is stabilized.

This is done because the accuracy of the crank signal is not secured when a crank signal is stored when the engine is not stabilized.

Preferably, the reference time stored in the ECU is set to be 5 seconds and when the operating time of the engine exceeds 5 seconds which is the reference time, the storing of the virtual crank signal (S200) is performed.

That is, if it is determined that the stabilization of the engine is maintained, the storing of the virtual crank signal (S200) is performed using the crank position sensor to store the crank signal while a crank shaft makes one turn.

The crank position sensor is installed at the crank shaft to output the crank signal having a waveform in response to the number of teeth of a trigger wheel installed on the whole surface of the crank shaft. Generally, the number of teeth is configured at 58 except a so-called ‘missing tooth’ (reference point).

Therefore, the ECU reads an on/off signal of a ‘pulse’ signal by 58 teeth which are generated at the time of one turn of the crank shaft and then stores the read on/off signal.

Meanwhile, after the storing of the virtual crank signal (S200), a determination of whether the crank position sensor is out of order (S300) is performed.

That is, the ECU determines whether a normal signal is not detected by the crank position sensor due to causes such as a breakdown of the crank position sensor, a disconnection of the wire, and a poor contact of the connector.

In this case, the normal signal is not detected by the crank position sensor and therefore if it is determined that the crank position sensor is out of order, the ECU performs the driving of the idle (S400).

That is, to prevent an engine stall due to the breakdown of the crank position sensor and implement minimally stable driving, the normal signal is not detected by the crank position sensor and therefore if it is determined that the crank position sensor is out of order, the ECU performs the driving of the idle (S400) controlling the engine RPM by the crank signal stored in the storing of the virtual crank signal.

Further, when determining whether the crank position sensor is out of order (S300), when the ECU detects the normal signal of the crank position signal, the engine RPM is controlled (S900) by the crank signal measured using the crank position sensor.

Meanwhile, after the driving of the idle (S400), detecting the engine RPM using the cam position sensor (S500) and determining second stabilization (S600), determining the stability of the engine is performed by comparing the engine RPM detected using the cam position sensor with the set reference value.

That is, the method for detecting an engine RPM using a cam position sensor generally uses twice as large of an RPM of the cam position sensor as the engine RPM.

In detail, the ECU divides a time between inputs of the sensing signal supplied from the cam position sensor by the input frequency of the crank position sensor to be input while the engine makes one turn, sets the divided time to be the input time per one crank signal, and calculates the engine RPM by a learning process corresponding to the set time.

Meanwhile, when determining the second stabilization (S600), the ECU determines the stability of the engine by comparing the engine RPM sensed using the cam position sensor with the set reference value.

That is, the stability of the engine is determined by comparing the reference value pre-stored in the ECU with the engine RPM sensed using the cam position sensor. In this case, the reference value is preferably set to be 500 rpm.

In this case, when the engine RPM sensed using the cam position sensor is smaller than 500 rpm which is the set reference value, controlling the engine (S800) based on the engine RPM measured using the crank signal stored in the storing of the virtual crank signal is performed.

The related art controls the engine RPM using the cam position sensor at the time of the abnormality of the crank position sensor. However, when the engine RPM is low, the engine may be stalled before the engine RPM is sensed using the cam position sensor.

Therefore, according to the exemplary embodiment of the present disclosure, when the engine RPM sensed using the cam position sensor is smaller than 500 rpm, which is the set reference value, the controlling of the engine based on the engine RPM measured using the crank signal previously stored in the storing of the virtual crank signal (S800) before the engine is stalled is performed to solve the existing problems.

That is, if it is determined that the engine is unstable, the engine is controlled based on the engine RPM measured using the crank signal stored in the storing of the virtual crank signal to prevent the engine stall.

Meanwhile, when the engine RPM sensed using the cam position sensor exceeds 500 rpm which is the set reference value, the controlling of the engine based on the engine RPM sensed using the cam position sensor is performed (S700).

That is, it is determined that the engine is stabilized when the engine RPM sensed using the cam position sensor exceeds 500 rpm which is the set reference value. In this case, the engine is controlled based on the engine RPM sensed using the cam position sensor.

According to the method for preventing an engine stall by a virtual crank signal according to the exemplary embodiment of the present disclosure configured of the above steps, it is possible to prevent the engine stall prior to performing the engine control by the cam position sensor which is caused due to the low engine RPM at the time of the breakdown of the crank position sensor.

According to the method of preventing an engine stall by a virtual crank signal according to the exemplary embodiments of the present disclosure, it is possible to prevent engine stall prior to controlling the engine using the cam position sensor, by controlling the engine based on the revolutions per minute measured by the pre-stored virtual crank signal at the time of the signal abnormality of the crank position sensor.

Although the present disclosure has been shown and described with respect to specific exemplary embodiments, it will be obvious to those skilled in the art that the present disclosure may be variously modified and altered without departing from the spirit and scope of the present disclosure as defined by the following claims.

What is claimed is:

1. A method for preventing an engine stall by a virtual crank signal, comprising:
a first stabilization determining step of determining stability of the engine by measuring an operating time of the engine;
a virtual crank signal storing step of storing a crank signal using a crank position sensor while a crank shaft makes one turn, if it is determined that the stability of the engine is maintained;
a step of determining whether the crank position sensor gets out of order; and
an idle driving step of controlling an engine RPM by the crank signal stored in the virtual crank signal storing step to perform idle driving of a vehicle at the time of a breakdown of the crank position sensor.

2. The method of claim 1, wherein in the step of determining whether the crank position sensor is out of order, the engine RPM is controlled by the crank signal measured using the crank position sensor if it is determined that the crank position sensor is normal.

3. The method of claim 1, further comprising:
after the idle driving step, a step of detecting the engine RPM using a cam position sensor;
a second stabilization determining step of determining the stability of the engine by comparing the engine RPM sensed using the cam position sensor with a set reference value; and
a step of controlling the engine based on the engine RPM sensed using the cam position sensor when the engine RPM sensed using the cam position sensor exceeds the set reference value.

4. The method of claim 1, further comprising:
after the idle driving step, a step of detecting the engine RPM using a cam position sensor;
a second stabilization determining step of determining the stability of the engine by comparing the engine RPM sensed using the cam position sensor with a set reference value; and
a step of controlling the engine based on the engine RPM sensed using the crank signal stored in the virtual crank signal storing step when the engine RPM sensed using the cam position sensor is smaller than the set reference value.

5. The method of claim 1, wherein in the first stabilization determining step of determining whether the engine is normally operated by measuring the operating time of the engine,
it is determined that the engine is stably operated when the operating time of the engine exceeds the set reference time by comparing the operating time of the engine with the set reference time.
